(19) United States
(12) Patent Application Publication
(10) Pub. No.: US 2024/0091879 A1
(43) Pub. Date: Mar. 21, 2024

(54) TEACHING DEVICE AND TEACHING METHOD FOR TEACHING OPERATION OF LASER PROCESSING DEVICE

(71) Applicant: Fanuc Corporation, Minamitsuru-gun, Yamanashi (JP)

(72) Inventor: Youhei Suzuki, Minamitsuru-gun, Yamanashi (JP)

(73) Assignee: Fanuc Corporation, Minamitsuru-gun, Yamanashi (JP)

(21) Appl. No.: 18/275,452

(22) PCT Filed: Feb. 22, 2022
(86) PCT No.: PCT/JP2022/007400

§ 371 Date: Aug. 2, 2023

(30) Foreign Application Priority Data
Feb. 26, 2021 (JP) 2021-030543

(51) Int. Cl. B23K 26/082; B23K 26/70

(52) U.S. Cl. CPC B23K 26/082; B23K 26/702

(57) ABSTRACT

A teaching device is provided with a processor. The processor generates a path image showing a moving path MP on which a laser processing device moves laser light with respect to a workpiece in laser processing, generates an input image for inputting a data set of a progress parameter indicating progress of the laser processing and a laser parameter of the laser light, and displays on the path image a position corresponding to the progress parameter on the moving path MP.

### CROSS REFERENCE TO RELATED APPLICATIONS

This is the U.S. National Phase application of PCT/JP2022/007400, filed Feb. 22, 2022, which claims priority to Japanese Patent Application No. 2021-030543, filed Feb. 26, 2021, the disclosures of each of these applications being incorporated herein by reference in their entireties for all purposes.

### FIELD OF THE INVENTION

The present disclosure relates to a teaching device for and a teaching method of teaching an operation of a laser processing device.

### BACKGROUND OF THE INVENTION

A teaching device for teaching a laser processing operation is known (e.g., Patent Document 1).

### PATENT LITERATURE

Patent Document 1: JP 2020-35404 A

### SUMMARY OF THE INVENTION

In the related art, in a laser process, there is a demand for a teaching device that can easily adjust a laser parameter at a desired position in a movement path of a laser beam relative to a workpiece.

In one aspect of the present disclosure, a teaching device configured to teach an operation of a laser processing device that is configured to perform a laser process on a workpiece by moving a laser beam irradiated on the workpiece relative to the workpiece. The teaching device includes a processor. The processor generates a path image that displays a movement path along which the laser processing device moves the laser beam relative to a workpiece in a laser process, generates an input image for inputting a data set of a progress parameter indicating a progress of the laser process and a laser parameter of the laser beam, and displays, in the path image, a position on the movement path corresponding to the progress parameter.

In another aspect of the present disclosure, a teaching method of teaching an operation of a laser processing device that is configured to perform a laser process on a workpiece by moving a laser beam irradiated on the workpiece relative to the workpiece. The teaching method includes generating, by a processor, a path image that displays a movement path along which the laser processing device moves the laser beam relative to the workpiece in the laser process; generating, by the processor, an input image for inputting a data set of a progress parameter indicating a progress of the laser process and a laser parameter of the laser beam; and displaying, by the processor, in the path image, a position on the movement path corresponding to the progress parameter.

The present disclosure allows an operator to freely adjust a laser parameter (e.g., a laser power) at a desired position on a movement path while visually recognizing the movement path indicated in a path image.

### BRIEF DESCRIPTION OF DRAWINGS

FIG. 1 is a schematic configuration diagram of a laser processing system according to an embodiment.

FIG. 2 is a block diagram of the laser processing system illustrated in FIG. 1.

FIG. 3 illustrates an example of a laser irradiation device illustrated in FIG. 1.

FIG. 4 is an example of a teaching image generated by a teaching device illustrated in FIG. 1, and illustrates a state in which a “Shape 1” tab is selected.

FIG. 5 illustrates a state in which a “Power” tab is selected in the teaching image illustrated in FIG. 4.

FIG. 6 illustrates a state in which a slider has been moved in the teaching image illustrated in FIG. 5.

FIG. 7 illustrates an example of a parameter setting image displayed when a speed setting image in FIG. 4 is selected.

FIG. 8 illustrates a state in which the “Power” tab is selected in the teaching image illustrated in FIG. 4 when “Shape 1” and “Shape 2” are set.

### DETAILED DESCRIPTION OF EMBODIMENTS OF THE INVENTION

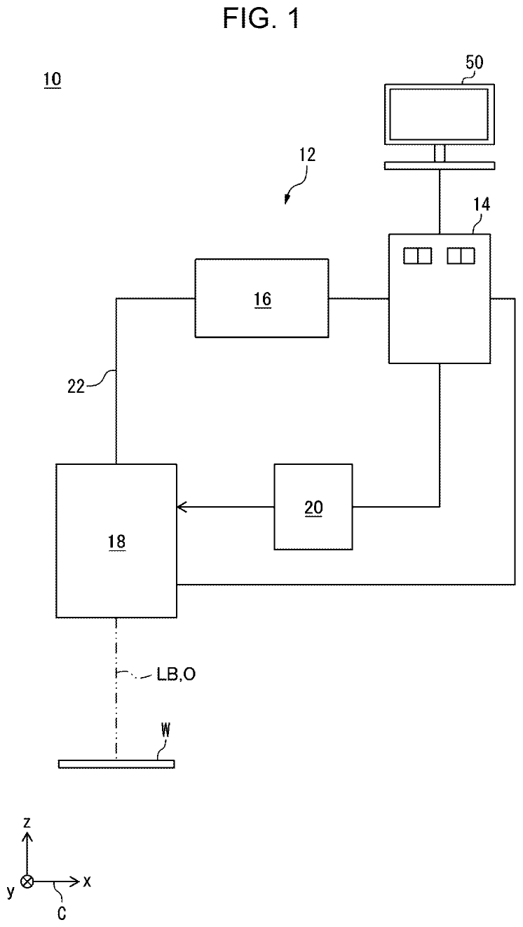

Embodiments of the present disclosure are described below in detail based on the drawings. Note that in the various embodiments described below, similar elements are denoted by the same reference signs, and overlapping descriptions are omitted. First, a laser processing system 10 according to an embodiment will be described with reference to FIGS. 1 to 3. The laser processing system 10 includes a laser processing device 12, a control device 14, and a teaching device 50.

The laser processing device 12 performs, under a command from the control device 14, a laser process (laser welding, laser cutting, or the like) on a workpiece W by irradiating the workpiece W with a laser beam LB and moving the irradiated laser beam LB relative to the workpiece W. Specifically, the laser processing device 12 includes a laser oscillator 16, a laser irradiation device 18, and a moving mechanism 20.

The laser oscillator 16 is a solid laser oscillator (e.g., YAG laser oscillator or fiber laser oscillator), a gas laser oscillator (e.g., carbon dioxide laser oscillator), or the like, which generates the laser beam LB internally through optical resonance in response to a command from the control device 14 and supplies the laser beam LB to the laser irradiation device 18 through a light guiding member 22. The light guiding member 22 includes an optical element such as optical fiber, a light guide path made of a hollow or translucent material, a reflection mirror, or an optical lens, and guides the laser beam LB to the laser irradiation device 18.

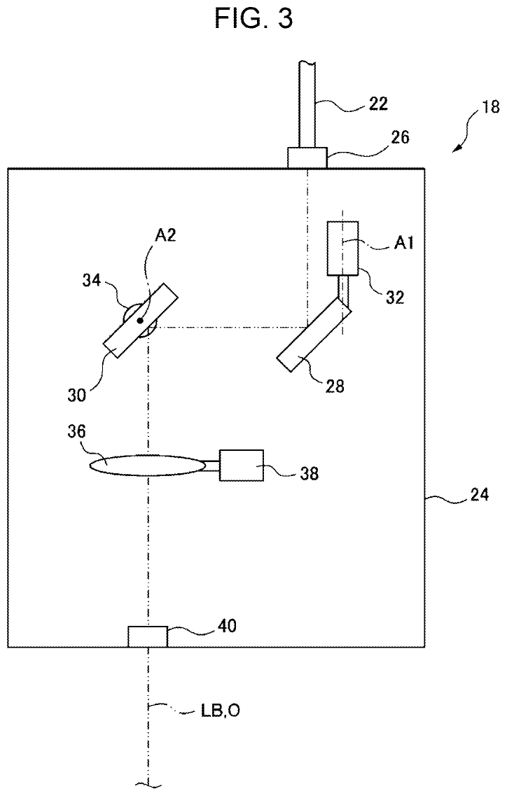

The laser irradiation device 18 is a laser scanner (galvano scanner), a laser processing head, or the like, which focuses the laser beam LB supplied from the laser oscillator 16 and irradiates the workpiece W. FIG. 3 schematically illustrates a configuration of the laser irradiation device 18 as a laser scanner. The laser irradiation device 18 illustrated in FIG. 3 includes a housing 24, a light receiver 26, mirrors 28 and 30, mirror drive devices 32 and 34, an optical lens 36, a lens drive device 38, and an emitter 40.

The housing 24 is hollow and defines a propagation path of the laser beam LB inside. The light receiver 26 is provided at the housing 24 to receive the laser beam LB propagating through the light guiding member 22. The mirror 28 is provided inside the housing 24 so as to be rotatable around an axis A1. The mirror 28 reflects, toward the mirror 30, the laser beam LB incident inside the housing 24 through the light receiver 26. The mirror drive device 32 is, for example, a servo motor that rotates the mirror 28 around the axis A1 in response to a command from the control device 14.

On the other hand, the mirror 30 is provided inside the housing 24 so as to be rotatable around an axis A2. The axis A2 may be substantially orthogonal to the axis A1. The mirror 30 reflects, toward the optical lens 36, the laser beam LB reflected by the mirror 28. The mirror drive device 34 is, for example, a servo motor that rotates the mirror 30 around the axis A2 in response to a command from the control device 14. In general, the mirrors 28 and 30 may be referred to as galvano mirrors, and the mirror drive devices 32 and 34 may be referred to as galvano motors.

The optical lens 36 includes a focus lens or the like and focuses the laser beam LB. In the present embodiment, the optical lens 36 is supported inside the housing 24 so as to be movable along an optical axis O direction of the incident laser beam LB. The lens drive device 38 includes a piezoelectric element, an ultrasonic vibrator, an ultrasonic motor, or the like, and displaces, in response to a command from the control device 14, the optical lens 36 along the optical axis O direction, thereby displacing the focus of the laser beam LB irradiated on the workpiece W along the optical axis O direction. The emitter 40 emits the laser beam LB focused by the optical lens 36 to the outside of the housing 24.

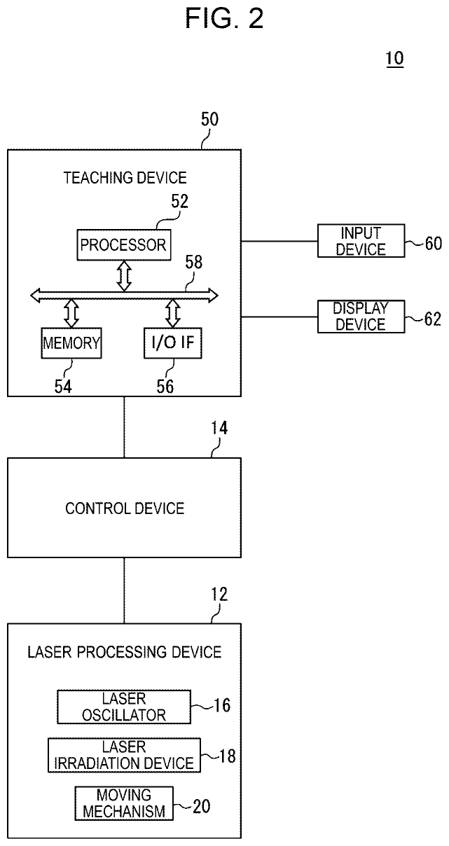

Again, referring to FIGS. 1 and 2, the moving mechanism 20 includes, for example, a servo motor, and moves the laser irradiation device 18 relative to the workpiece W. For example, the moving mechanism 20 is an articulated robot that can move the laser irradiation device 18 to any position in a coordinate system C. Alternatively, the moving mechanism 20 may include a plurality of ball screw mechanisms that move the laser irradiation device 18 along an x-y plane of the coordinate system C as well as along a z-axis direction of the coordinate system C.

The coordinate system C is, for example, a world coordinate system that defines a three-dimensional space of a work cell, a moving mechanism coordinate system (e.g., a robot coordinate system) for controlling an operation of the moving mechanism 20, or a workpiece coordinate system that defines the coordinates of the workpiece W, and is a control coordinate system for automatically controlling an operation of the laser processing device 12.

The control device 14 controls the operation of the laser processing device 12. Specifically, the control device 14 is a computer including a processor (CPU, GPU, or the like) and a memory (ROM, RAM, or the like). The control device 14 controls a laser beam generation operation by the laser oscillator 16. The control device 14 moves the laser irradiation device 18 relative to the workpiece W by operating the moving mechanism 20. The control device 14 changes an orientation of each of the mirrors 28 and 30 by respectively operating the mirror drive devices 32 and 34 of the laser irradiation device 18 so that an irradiation point of the laser beam LB irradiated on the workpiece W can be moved at a high speed relative to the workpiece W.

The teaching device 50 is for teaching the operation of the laser processing device 12. As illustrated in FIG. 2, the teaching device 50 is a computer including a processor 52, a memory 54, and an I/O interface 56. Note that the teaching device 50 may be any type of computer, for example, a desktop PC or a tablet PC.

The processor 52 includes a CPU, a GPU, or the like, and is communicably connected to the memory 54 and the I/O interface 56 via a bus 58. The processor 52 performs arithmetic processing to achieve a teaching function described below, while communicating with the memory 54 and the I/O interface 56.

The memory 54 includes a RAM or a ROM, and temporarily or permanently stores various data. The I/O interface 56 includes, for example, an Ethernet (trade name) port, a USB port, an optical fiber connector, or an HDMI (trade name) terminal, and communicates data with an external device in a wired or wireless manner under a command from the processor 52.

The teaching device 50 is provided with an input device 60 and a display device 62. The input device 60 includes a keyboard, a mouse, a touch panel, or the like, and accepts data input from an operator. The display device 62 includes a liquid crystal display, an organic EL display, or the like, and displays various data.

The input device 60 and the display device 62 are communicably connected to the I/O interface 56 in a wired or wireless manner. Note that the input device 60 and display device 62 may be provided separately from a housing of the teaching device 50 or integrated into the housing of the teaching device 50.

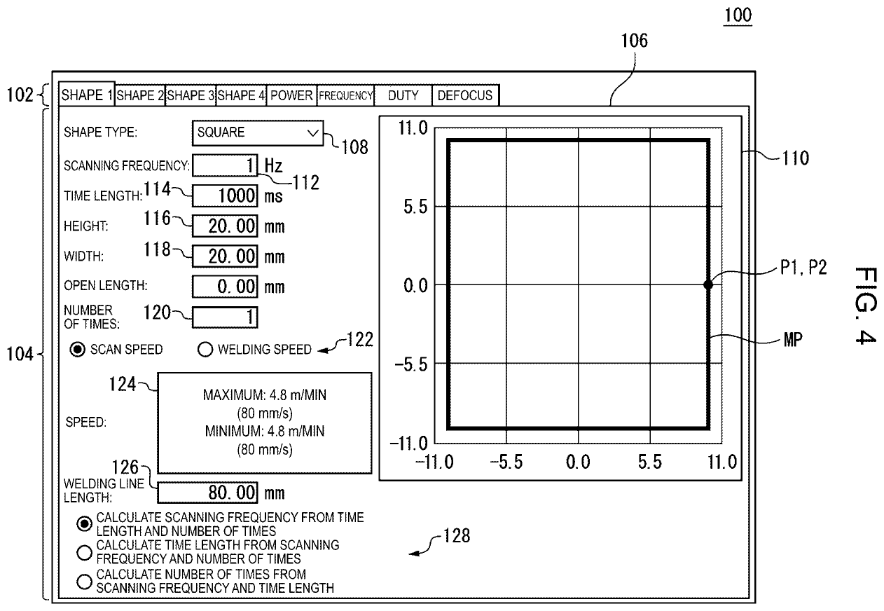

A method of teaching the operation of the laser processing device 12 using the teaching device 50 is described below with reference to FIGS. 4 to 6. Upon receiving a teaching start command from the operator through the input device 60, the processor 52 generates a teaching image 100 illustrated in FIG. 4 as image data using computer graphics (CG) and displays the image data on the display device 62. The teaching image 100 is a graphical user interface (GUI) for assisting the operator in teaching work, and includes a tab image area 102 and a parameter setting image area 104.

In the present embodiment, a total of eight types of tab images are displayed in the tab image area 102, which are “Shape 1”, “Shape 2”, “Shape 3”, “Shape 4”, “Power”, “Frequency”, “Duty”, and “Defocus”. The operator can operate the input device 60 to select one of these eight types of tabs by clicking on the image.

The processor 52 generates, in response to an input signal received from the operator through the input device 60, a parameter setting image corresponding to the tab selected by the operator and displays the generated image in the parameter setting image area 104. FIG. 4 illustrates a state in which a parameter setting image 106 corresponding to the “Shape 1” tab is displayed in the parameter setting image area 104.

The operator can set various parameters through the parameter setting image 106, such as a shape of a movement path MP along which the laser processing device 12 (specifically, the laser irradiation device 18) moves the laser beam LB relative to the workpiece W in the laser process, a speed V of the laser beam LB (specifically, the irradiation point on the workpiece W), and a number of times N the laser beam LB is repeatedly moved along the movement path MP.

Specifically, in the parameter setting image 106, a shape selection image 108 for selecting “Shape type”, a path image 110, a numerical value input image 112 for “Scanning frequency”, a numerical value input image 114 for “Time length”, a numerical value input image 116 for “Height”, a numerical value input image 118 for “Width”, a numerical value input image 120 for “Number of times”, a speed selection image 122, a speed setting image 124, a welding line length image 126, and a calculation method selection image 128 are displayed.

The shape selection image 108 is for selecting the shape of the movement path MP. Specifically, when the operator operates the input device 60 and clicks on the shape selection image 108, the processor 52 displays a list of a plurality of “Shape type” items in the shape selection image 108 as, for example, a pull-down image, in response to an input signal from the input device 60.

For example, the “Shape type” of the movement path MP may include various shapes, such as “Square”, “Circle”, “Eight-shape”, “C-shape”, and “Triangular waveform”. The operator can operate the input device 60 to select one of the plurality of “Shape type” items displayed in the shape selection image 108 by clicking on the image.

The path image 110 displays the movement path MP of the “Shape type” selected in the shape selection image 108. FIG. 4 illustrates a case when “Square” is selected as the “Shape type”. The movement path MP includes a start point P1 and an end point P2. In the example illustrated in FIG. 4, the start point P1 and the end point P2 are set at a midpoint of a right side of the square. In the case of the square movement path MP, the laser processing device 12 moves the laser beam LB in a clockwise (or counterclockwise) direction along the movement path MP from the start point P1 to the end point P2.

Note that the processor 52 may further generate an image for selecting positions of the start point P1 and end point P2 on the movement path MP and display the generated image in the parameter setting image 106. The processor 52 may further generate an image for selecting the direction (e.g., clockwise or counterclockwise) in which the laser beam LB is moved from the start point P1 to the end point P2 along the movement path MP and may display the generated image in the parameter setting image 106. In the present description, moving the laser beam LB from the start point P1 to the end point P2 along the movement path MP once is referred to as a single “Scan”.

The numerical value input image 116 for “Height” is for inputting a height dimension of the “Shape type” selected in the shape selection image 108 (horizontal direction of the page of FIG. 4). The operator can operate the input device 60 to input a numerical value for “Height” into the numerical value input image 116. The processor 52 displays the movement path MP with the input “Height” in the path image 110 in response to an input signal from the input device 60. In the example illustrated in FIG. 4, “20” is input in the numerical value input image 116 for “Height”, and a square movement path MP with a height of 20 mm is displayed in the path image 110.

The numerical value input image 118 for “Width” is for inputting a width dimension of the “Shape type” selected in the shape selection image 108 (vertical direction of the page of FIG. 4). The operator can operate the input device 60 to input a numerical value for “Width” into the numerical value input image 118. The processor 52 displays the movement path MP with the input “Width” in the path image 110. In the example illustrated in FIG. 4, “20” is input in the numerical value input image 118 for “Width”, and a square movement path MP with a width of 20 mm is displayed in the path image 110.

“Number of times” in the numerical value input image 120 indicates the number of times N the scan is repeated. “Scanning frequency” in the numerical value input image 112 indicates the number of scans f (unit: Hz) in 1 second. “Time length” in the numerical value input image 114 refers to a time length t_{S} required to scan the number of times N input to the numerical value input image 120, and is obtained, as the time length t_{S}=t₀×N, by multiplying a time length t₀ required for one “Scan” by the number of times N. The operator can operate the input device 60 to input “Scanning frequency”, “Time length”, and “Number of times” into the numerical value input images 112, 114, and 120, respectively.

On the other hand, in the calculation method selection image 128, an image of an option “Calculate scanning frequency from time length and number of times”, an image of an option “Calculate time length from scanning frequency and number of times”, and an image of an option “Calculate number of times from scanning frequency and time length” are displayed. The operator can operate the input device 60 to select one of these three options in the image.

When the option “Calculate scanning frequency from time length and number of times” is selected, the processor 52 accepts an input signal from the operator and displays the numerical value input image 112 of the “Scanning frequency” so as to indicate that numerical input is not possible. The operator inputs the time length t_{S} in the numerical value input image 114 for “Time length” and the number of times N in the numerical value input image 120 for “Number of times”. In response to the input signals of the time length t_{S} and number of times N, the processor 52 automatically calculates the scanning frequency f as f=N/t_{S} and displays the calculated value in the numerical value input image 112.

FIG. 4 illustrates an example where the option “Calculate scanning frequency from time length and number of times” is selected in the calculation method selection image 128, t_{S}=1000 msec is input in the numerical value input image 114, and the number of times N=1 is input in the numerical value input image 120. In this case, as illustrated in FIG. 4, the processor 52 displays (specifically, displays in a different color than that of the numerical value input images 114 and 120) the numerical value input image 112 for the “Scanning frequency” so as to make it visually recognizable that no numerical value can be input. The processor 52 then automatically calculates the scanning frequency f as f=N/t_{S} (=1 Hz) and displays the calculated value in the numerical value input image 114.

On the other hand, when the option “Calculate time length from scanning frequency and number of times” is selected in the calculation method selection image 128, the processor 52 displays the numerical value input image 114 for “Time length” so as to indicate that numerical value input is not possible. The operator inputs the scanning frequency f and number of times N, and the processor 52 calculates the time length t_{S} from these input signals as t_{S}=N/f and displays the calculated value in the numerical value input image 114. Note that the same as the other options applies to the option “Calculate number of times from scanning frequency and time length”.

“Welding line length” in the welding line length image 126 indicates a total scanning distance 1 when the movement path MP defined by the input “Shape type”, “Height” and “Width” is scanned the number of times N input in the numerical value input image 120 for “Number of times”. The processor 52 automatically calculates and displays the welding line length 1 in the welding line length image 126 in accordance with the “Shape type”, “Height”, “Width”, and “Number of times” input by the operator.

In the speed selection image 122, an image of an option “Scan speed” and an image of an option “Welding speed” are displayed. The operator can operate the input device 60 to select one of these two options in the image. “Scan speed” indicates a speed V_{S} at which the laser processing device 12 (specifically, the laser irradiation device 18) moves the laser beam LB along the movement path MP relative to the workpiece W.

On the other hand, “Welding speed” indicates a speed component V_{W} of the speed V_{S} along a reference direction. For example, in the movement path MP of the path image 110 in FIG. 4, the reference direction is defined as a horizontal axis direction of the path image 110. In this case, the welding speed V_{W} is the horizontal speed component of the speed V_{S} of the laser beam LB (specifically, the irradiation point) moving along the movement path MP.

The speed setting image 124 is for setting the scan speed V_{S} or the welding speed V_{W} selected in the speed selection image 122. Note that a function of the speed setting image 124 will be described below in detail. In the example illustrated in FIG. 4, in the speed setting image 124, a maximum speed and a minimum speed individually set by the operator are displayed. FIG. 4 illustrates an example in which the scan speed V_{S} is set to a constant speed V_{S}=4.8 m/min (or 80 mm/sec).

As described above, in the parameter setting image 106, the operator can set various parameters such as the shape type of the movement path MP, the time length t_{S}, the number of times N, and the speed V_{S} or V_{W}. The processor 52 stores, in the memory 54, setting information on various parameters received from the operator. Note that the parameter setting images corresponding to “Shape 2”, “Shape 3”, and “Shape 4” displayed in the tab image area 102 are also the same as the parameter setting image 106.

On the other hand, of the tabs displayed in the tab image area 102, the tabs for “Power”, “Frequency”, “Duty”, and “Defocus” are for setting a laser parameter LP that defines optical properties of the laser beam LB. “Power” is for setting a laser power LP1 of the laser beam LB generated by the laser oscillator 16 in a laser process, and “Frequency” is for setting a pulse frequency LP2 of the laser beam LB generated by the laser oscillator 16.

“Duty” is for setting a duty ratio LP3 of the laser beam LB, and “Defocus” is for setting a shift distance LP4 by which the focus of the laser beam LB is shifted from a surface of the workpiece W. The processor 52, generates, in response to an input signal for selecting the tab for “Power”, “Frequency”, “Duty”, or “Defocus”, a parameter setting image corresponding to the selected tab and displays the generated image in the parameter setting image area 104.

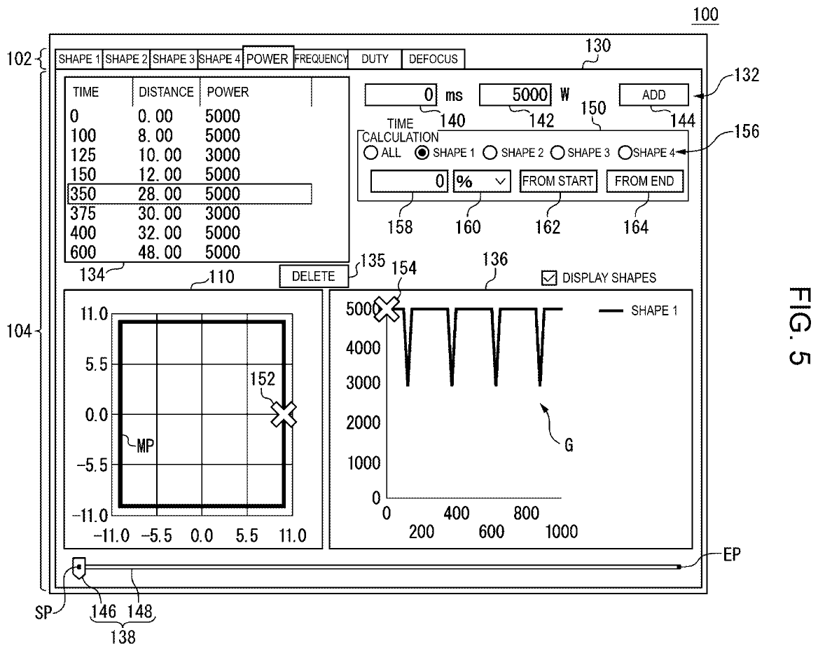

FIG. 5 illustrates a state in which the “Power” tab is selected and a parameter setting image 130 corresponding to the “Power” tab is displayed in the parameter setting image area 104. The operator can set the laser power LP1 of the laser beam LB as the laser parameter LP through the parameter setting image 130.

Specifically, in the parameter setting image 130, the path image 110, a data set input image 132, a data-set image 134, a graph image 136, a slider image 138, and a time calculation image 150 are displayed. The data set input image 132 is for inputting a data set DS of a progress parameter PP and the laser parameter LP. The progress parameter PP is a parameter that quantitatively represents a progress of the laser process, and includes, for example, an elapsed time length tₑ from the start of the laser process, a distance d by which the laser processing device 12 has moved the laser beam LB along the movement path MP from the start of the laser process, or a progress rate R of the laser process.

As an example, the progress rate R may be a ratio R1 (i.e., R1=tₑ/tₜ) of the elapsed time length tₑ to a total required time length tₜ from the start to the end of the laser process. For example, in the present embodiment, only the movement path MP of “Shape 1” is set so that the total required time length tₜ becomes “Time length” is =1000 msec in FIG. 4.

As another example, the progress rate R may be a ratio R2 (i.e., R2=d/dₜ) of the above distance d to a total distance dₜ by which the laser processing device 12 moves the laser beam LB from the start to the end of the laser process. For example, in the present embodiment, only the movement path MP of “Shape 1” is set, so that the total distance dₜ is “Welding line length” in FIG. 4, which is 1=80 mm.

FIG. 5 illustrates an example in which the elapsed time length tₑ is selected as the progress parameter PP. The data set input image 132 includes a progress parameter input image 140, a laser parameter input image 142, and an add button image 144. In the example illustrated in FIG. 5, the progress parameter PP is the elapsed time length tₑ and the “Power” tab is selected as the laser parameter LP.

Thus, the progress parameter input image 140 displays such that the elapsed time length tₑ (unit: msec) is to be input and the laser parameter input image 142 displays such that the laser power LP1 (unit: W) is to be input. The operator can operate the input device 60 to input the elapsed time length tₑ and the laser power LP1 into the progress parameter input image 140 and the laser parameter input image 142, respectively.

The add button image 144 is a button for registering, as a laser processing condition LC, the data set DS of the progress parameter PP (in the present example, the elapsed time length tₑ) and the laser parameter LP (in the present example, the laser power LP1), which have been input in the progress parameter input image 140 and the laser parameter input image 142, respectively.

When the operator operates the input device 60 and clicks on the add button image 144, the data set DS of the input progress parameter PP (the elapsed time length tₑ) and the input laser parameter LP (the laser power LP1) are stored in the memory 54 as the laser processing condition LC and registered in the list illustrated in the data-set image 134.

The data-set image 134 displays the data set DS of the progress parameter PP and the laser parameter LP in list form. In the example illustrated in FIG. 5, in the data-set image 134, images of tabs “Time”, “Distance”, and “Power” are displayed. “Time” corresponds to the elapsed time length tₑ described above. “Distance” corresponds to the distance d described above, and “Power” corresponds to the laser power LP1 described above.

In the data-set image 134, a plurality of data sets DS, which include the elapsed time length tₑ and the distance d as the progress parameter PP and the laser power LP1 as the laser parameter LP, are displayed side by side in the order of the magnitude of the elapsed time length tₑ (specifically, in ascending order). Here, in the present embodiment, since the constant scan speed V_{S}=4.8 m/min (80 mm/sec) is set in FIG. 4, the distance d at the elapsed time length tₑ input to the progress parameter input image 140 can be calculated as d=V_{S}×tₑ.

When a data set DS is registered through the add button image 144, the processor 52 automatically calculates the distance d corresponding to the registered elapsed time length tₑ, creates a list of a data set DS of the elapsed time length tₑ, the distance d, and the laser parameter LP, and displays the list in the data-set image 134.

Note that every time the operator operates the input device 60 and clicks on the “Time” tab, the processor 52 may update the data-set image 134 such that the order of the data set DS illustrated in the data-set image 134 is switched between ascending and descending order of the elapsed time length tₑ. Similarly, the processor 52 may switch the order of the data set DS for “Distance” or “Power” between ascending and descending order of the distance d or the laser parameter LP each time the corresponding tab is clicked.

The operator can also operate the input device 60 to select one of the data sets DS illustrated in the data-set image 134 by clicking on the image. The example in FIG. 5 illustrates a state in which the data set DS is selected with “Time” being 350 msec, “Distance” being 28.00 mm, and “Power” being 5000 W.

In a state in which one data set DS is selected, when the operator operates the input device 60 and clicks on a delete button image 135 displayed below the data-set image 134, the processor 52 deletes the one data set DS selected in the data-set image 134 from the laser processing condition LC stored in the memory 54 and also deletes the one data set DS from the list shown in the data-set image 134, in response to the input signal from the operator.

When the operator selects one of the data sets DS in the data-set image 134, the processor 52 automatically displays the “Time” of the selected data set DS in the progress parameter input image 140 and displays the “Power” of the selected data set DS in the laser parameter input image 142. The operator can change the “Power” of the selected data set DS by changing the value of the laser parameter input image 142 and clicking on the add button image 144.

The graph image 136 displays a graph G representing a relationship between the progress parameter PP and the laser parameter LP. In the example illustrated in FIG. 5, the graph G illustrates the relationship between the elapsed time length tₑ and the laser power LP1 (i.e., the graph corresponding to a list of the data sets DS for “Time” and “Power” illustrated in the data-set image 134).

The slider image 138 includes an image of a slider 146 and an image of a section 148 from a start point SP to an end point EP of the progress parameter PP. In the section 148, the start point SP indicates the start point of the laser process, and the end point EP indicates the end point of the laser process. In the present embodiment, since the elapsed time length tₑ is selected as the progress parameter PP, the section 148 represents the elapsed time length tₑ. Since only the movement path MP having “Shape 1” is set, the start point SP in the section 148 is tₑ=0, while the end point EP is the time length t_{S} in FIG. 4 (i.e., tₑ=t_{S}=1000 msec).

The slider 146 is displayed so as to move in the section 148 in response to an input signal from the operator, and designates the progress parameter PP (in the present example, the elapsed time length tₑ). Specifically, when the operator operates the input device 60 to move the slider 146 in the image (so-called drag-and-drop), the processor 52 updates the slider image 138 so as to move the slider 146 in the image in the section 148 in response to the input signal from the input device 60.

When the slider 146 is stopped at a position of choice in the section 148, the processor 52 then reads the progress parameter PP (the elapsed time length tₑ) designated by the slider 146 at the position of choice. The processor 52 then automatically inputs (i.e., displays) the read progress parameter PP (the elapsed time length tₑ) into the progress parameter input image 140 of the data set input image 132, and automatically inputs (i.e., displays) the laser parameter LP (the laser power LP1) corresponding to the progress parameter PP (the elapsed time length tₑ) into the laser parameter input image 142.

On the other hand, the processor 52 displays a mark 152 in the path image 110 of the parameter setting image 130. This mark 152 is an image for highlighting a position in the movement path MP in the path image 110 corresponding to the progress parameter PP (the elapsed time length tₑ) input to the progress parameter input image 140.

As described above, the distance d of movement of the laser beam LB along the movement path MP from the start point P1 can be obtained from the equation d=V_{S}×tₑ using the elapsed time length tₑ and the scan speed V_{S} of the laser beam LB. Thus, the processor 52 obtains a position on the movement path MP corresponding to any elapsed time length tₑ and can generate the path image 110 so as to display the mark 152 at the position.

The processor 52 displays a mark 154 in the graph image 136. This mark 154 is an image for highlighting a position in the graph G in the graph image 136 corresponding to the progress parameter PP (the elapsed time length tₑ) input to the progress parameter input image 140. The processor 52 obtains a position in the graph G corresponding to any elapsed time length tₑ based on the list of data sets DS, and can generate the graph image 136 so as to display the mark 154 at the position.

Note that in the present embodiment, the marks 152 and 154 are each displayed as X-shaped marks. However, the marks 152 and 154 may each be a mark of any shape, such as a circle, triangle, or square, or may be displayed having any visual effect visible to the operator, such as flashing signals.

In the example illustrated in FIG. 5, the slider 146 is stopping at the start point SP (tₑ=0) of the elapsed time length tₑ, tₑ=0 is designated by the slider 146, and “0 ms” is input (displayed) in the progress parameter input image 140. Thus, the mark 152 in the path image 110 is displayed at the start point P1 on the movement path MP, and the mark 154 in the graph image 136 is displayed at a point on the graph G with tₑ=0.

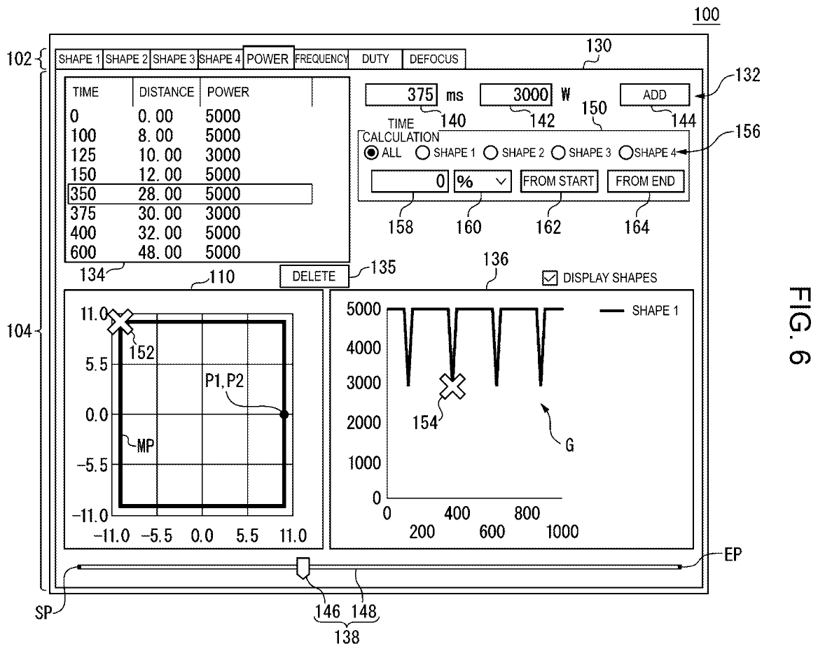

On the other hand, as illustrated in FIG. 6, when the operator moves the slider 146 along the section 148, the elapsed time length tₑ designated by the slider 146 changes. In response to this, the processor 52 updates the path image 110 and the graph image 136 so as to displace the position of the mark 152 in the path image 110 and the position of the mark 154 in the graph image 136.

Thus, in the present embodiment, the operator can freely designate the progress parameter PP (the elapsed time length tₑ) by moving the slider 146 in the image, and can freely input the laser parameter LP (the laser power LP1) corresponding to the designated progress parameter PP (the elapsed time length tₑ) into the laser parameter input image 142 in the data set input image 132. The operator can then register a new data set DS by operating the add button image 144 after inputting the laser parameter LP.

The time calculation image 150 is for obtaining the elapsed time length tₑ (“Time” in the drawing), which is one of the progress parameters PP, from the distance d or the progress rate R, which are the other progress parameters PP. Specifically, the time calculation image 150 includes a shape selection image 156, a numerical value input image 158, a parameter selection image 160, a start point assign image 162, and an end point assign image 164.

The shape selection image 156 is for selecting “Shape 1”, “Shape 2”, “Shape 3”, “Shape 4”, or “All”. When one of “Shape 1” to “Shape 4” is selected, the elapsed time length tₑ is obtained from the distance d or the progress rate R, when performing the laser process along the movement path MP having the selected “Shape”. On the other hand, assuming that a plurality of “Shapes” from “Shape 1” to “Shape 4” are set in the teaching image 100 illustrated in FIG. 4 by selecting “All”, the elapsed time length tₑ is obtained from the distance d or the progress rate R, when performing continuous laser processes along the movement paths MP having all of the set “Shapes”.

Since only the movement path MP having “Shape 1” is set in the present embodiment, “Shape 2”, “Shape 3” and “Shape 4” are not selectable in the shape selection image 156. Regardless of whether “Shape 1” or “All” is selected, the elapsed time length tₑ is obtained, when performing the laser process along the square movement path MP illustrated in the path image 110. The example in FIG. 5 illustrates a state in which “Shape 1” is selected in the shape selection image 156.

The parameter selection image 160 is for selecting the distance d or the progress rate R for obtaining the elapsed time length tₑ. For example, when an operator operates the input device 60 and clicks on the parameter selection image 160, the processor 52 displays a list of three options in the parameter selection image 160 as, for example, a pull-down image, in response to the input signal from the input device 60, the three options being the distance d (unit: mm), the progress rate R1 (=tₑ/tₜ, unit: %), and a progress rate R2 (R2=d/dₜ, unit: %).

The start point assign image 162, which is displayed as a “From start” image, is for designating the start point P1 of the movement path MP having “Shape 1” selected in the shape selection image 156 as a reference for “Time calculation”. The operator can operate the input device 60 and designate the start point P1 of the movement path MP as the reference for “Time calculation” by clicking on “From start” in the start point assign image 162.

On the other hand, the end point assign image 164, which is displayed as a “From end” image, is for designating the end point P2 of the movement path MP having “Shape 1” selected in the shape selection image 156 as the reference for “Time calculation”. The operator can operate the input device 60 and designate the end point P2 of the movement path MP as the reference for “Time calculation” by clicking on “From end” in the end point assign image 164.

Specific examples of “Time calculation” are described below. As an example, it is assumed that the operator selects the distance d in the parameter selection image 160, selects “From start” in the start point assign image 162, and inputs d=30 mm in the numerical value input image 158. In this case, in response to the input signal from the operator, the processor 52 obtains the “Time” (the elapsed time length tₑ) corresponding to the position on the movement path MP advanced by a distance d=30 mm from the start point SP (in the present example, the start point P1) of the laser process as tₑ=375 msec using the distance d and the scan speed V_{S} (see the data-set image 134).

The processor 52 then displays the obtained “Time” tₑ=375 msec in the progress parameter input image 140, and the laser parameter LP (the laser power LP1), which is stored as the data set DS at this point and corresponds to the elapsed time length tₑ, in the laser parameter input image 142. Thus, the operator can designate, from the distance d, the “Time” (the elapsed time length tₑ) and input the laser parameter LP at the “Time” into the laser parameter input image 142 and register the values as the data set DS of the progress parameter PP and the laser parameter LP.

As another example, it is assumed that the operator selects the distance d in the parameter selection image 160, selects “From end” in the end point assign image 164, and inputs d=50 mm in the numerical value input image 158. In this case, in response to the input signal from the operator, the processor 52 obtains, as tₑ=375 msec, the “Time” (the elapsed time length tₑ) corresponding to the position on the movement path MP (in the present example, the position is at 30 mm from the start point P1 since the total distance dₜ=80 mm) receded by the distance d=50 mm from the end point EP (in the present example, the end point P2) of the laser process.

As still another example, it is assumed that the operator selects the progress rate R1 in the parameter selection image 160, selects “From start” in the start point assign image 162, and inputs R1=10% in the numerical value input image 158. In this case, the processor 52 obtains, in response to the input signal from the operator, the “Time” (the elapsed time length tₑ) from the start point SP (the start point P1) of the laser process using the equation R1=tₑ/tₜ=0.1. In the present embodiment, since the total required time length tₜ=1000 msec, the processor 52 obtains the “Time” as tₑ=100 msec and displays the obtained value in the progress parameter input image 140, and also displays the laser power LP1=5000 W corresponding to tₑ=100 msec in the laser parameter input image 142.

When the operator selects the progress rate R1 in the parameter selection image 160, selects “From end” in the end point assign image 164, and inputs R1=10% in the numerical value input image 158, the processor 52 obtains the “Time” as a point in time that is traced back by the time length tₑ=100 msec (i.e., 900 msec from the start point SP) from the end point EP (the end point P2) of the laser process.

As still another example, it is assumed that the operator selects the progress rate R2 in the parameter selection image 160, selects “From start” in the start point assign image 162, and inputs R2=10% in the numerical value input image 158. In this case, in response to the input signal from the operator, the processor 52 obtains, as the elapsed time length tₑ=100 msec, the “Time” corresponding to the position on the movement path MP advanced by distance d=dₜ×0.1=8 mm from the start point SP (the start point P1) of the laser process.

When the operator selects the progress rate R2 in the parameter selection image 160, selects “From end” in the end point assign image 164, and inputs R2=90% in the numerical value input image 158, the processor 52 obtains the “Time” as the time corresponding to the position (i.e., the position from the start point P1 by distance d=8 mm) on the movement path MP that is receded by a distance d=dₜ×0.9=72 mm from the end point EP (the end point P2) of the laser process.

Thus, the operator can designate a “Time” (elapsed time length tₑ) as one of the progress parameters PP from the other progress parameters PP, which are the distance d, the progress rate R1 or R2, and freely register the data set DS of the elapsed time length tₑ and the laser power LP1.

Through the above parameter setting images 106 and 130, the operator can set, as the laser processing condition LC, various parameters such as the shape of movement path MP, the scan speed V_{S}, the number of times N, and the data sets DS. Based on the set laser processing condition LC (i.e., various parameters) and position data (coordinates) of a work target position TP of the workpiece W in the coordinate system C, the processor 52 generates a processing program PG for causing the laser processing device 12 to perform the laser process on the workpiece W, and stores the processing program PG in the memory 54.

The processing program PG defines, for example, the laser processing condition LC set by the operator, the position data of the work target position TP, the data indicating a positional relationship between the work target position TP and the movement path MP, and the commands to the laser processing device 12 (specifically, the laser oscillator 16, the laser irradiation device 18, and the moving mechanism 20).

The control device 14 controls the laser processing device 12 in accordance with the generated processing program PG and performs the laser process on the workpiece W. Specifically, the control device 14 first operates the moving mechanism 20 to move the laser irradiation device 18 to a predetermined work position relative to the workpiece W positioned at a known installation position in the coordinate system C.

The control device 14 then activates the laser oscillator 16 to supply the laser beam LB to the laser irradiation device 18, and operates the mirror drive devices 32 and 34 to change the orientation of the mirrors 28 and 30, respectively, to move the laser beam LB (specifically, the irradiation point) irradiated on the workpiece W along the movement path MP that is set to be in a known positional relationship relative to the work target position TP. At this time, the control device 14 controls the laser parameter LP (the laser power LP1, the pulse frequency LP2, the duty ratio LP3, the shift distance LP4) of the laser beam LB to a value set by the operator. Thus, the control device 14 performs the laser process relative to the work target position TP on the workpiece W in accordance with the processing program PG.

As described above, in the present embodiment, the processor 52 generates, in the teaching image 100, the path image 110 that displays the movement path MP and the input image 132 for inputting the data set DS, and displays, as the mark 152, the position on the movement path MP corresponding to the progress parameter PP in the path image 110.

This configuration allows the operator to freely adjust the laser parameter LP (e.g., the laser power LP1) at a desired position on the movement path MP. For example, when the laser process is performed with a constant laser power LP1 along the square movement path MP illustrated in FIG. 5, the workpiece W may get overheated at positions on the movement path MP, corresponding to the four vertices of the square, and as a result, defects such as burning may occur. To avoid such defects, there is a demand to lower the laser power LP1 at positions on the movement path MP corresponding to the four vertices of the square.

According to the present embodiment, since the processor 52 displays in the path image 110 the position on the movement path MP corresponding to the elapsed time length tₑ designated by the operator, the operator can easily ascertain the elapsed time length tₑ at the position (e.g., each vertex) on the movement path MP where the operator wants to lower the laser power LP1, and can adjust (e.g., lower) the laser power LP1 corresponding to the elapsed time length tₑ appropriately through the input image 132. As a result, operations to perform a high-quality laser process can be taught to the laser processing device 12.

In the present embodiment, the processor 52 generates the graph image 136 displaying the graph Gin the parameter setting image 130 illustrated in FIG. 5, and displays, as the mark 154, the position in the graph G corresponding to the progress parameter PP in the graph image 136. With this configuration, the operator can easily visually ascertain the value of the laser parameter LP (the laser power LP1) at the desired progress parameter PP.

In the present embodiment, the processor 52 generates data-set image 134 in which the plurality of the data sets DS are displayed side by side in the order of the magnitude of the progress parameter PP (e.g., “Time”) in the parameter setting image 130. With this configuration, the operator can sort the plurality of the data sets DS in the order of the magnitude of the desired progress parameter PP to organize the data sets DS so as to be visually recognized easily.

In the present embodiment, the processor 52 generates the slider image 138 that displays the slider 146 moving in the section 148 in the parameter setting image 130, and displays, in the path image 110 as the mark 152, the position on the movement path MP corresponding to the progress parameter PP designated by the slider 146.

With this configuration, the operator can designate a desired progress parameter PP (in the present example, the elapsed time length tₑ) by operating the slider 146 in the image, and the position on the movement path MP corresponding to the progress parameter PP can be visually recognized easily with the path image 110. Thus, adjustments to the data sets DS can be easily made through more intuitive operations.

Note that parameter setting images 130′ for “Frequency”, “Duty”, and “Defocus” displayed in the tab image area 102 are each substantially the same as the parameter setting image 130 for “Power”, but the units of the laser parameter input image 142, the units of the vertical axis in the graph image 136, and the laser parameter LP indicated in the data-set image 134 are each unique.

Specifically, in the parameter setting image 130′ for “Frequency”, the unit of the laser parameter input image 142 is “Hz”, and the data set DS of the elapsed time length tₑ as the progress parameter PP and the pulse frequency LP2 can be input. The vertical axis of the graph image 136 will indicate the pulse frequency LP2, which will be displayed as the laser parameter LP in the data-set image 134.

In the parameter setting image 130′ for “Duty”, the unit of the laser parameter input image 142 is “%”, and the data set DS of the elapsed time length tₑ and duty ratio LP3 can be input. The vertical axis of the graph image 136 will indicate the duty ratio LP3, which will be displayed as the laser parameter LP in the data-set image 134.

In the parameter setting image 130′ for “Defocus”, the unit of the laser parameter input image 142 is “mm”, and the data set DS of the elapsed time length tₑ and the shift distance LP4 can be input. The vertical axis of the graph image 136 will indicate the shift distance LP4, which will be displayed as the laser parameter LP in the data-set image 134.

When a positive value is input to the laser parameter input image 142 in the parameter setting image 130′ for “Defocus”, the processor 52 may set the shift distance LP4 to shift the focus of the laser beam LB from the surface of the workpiece W in the positive z-axis direction of the coordinate system C. On the other hand, when a negative value is input to the laser parameter input image 142, the processor 52 may set the shift distance LP4 to shift the focus of the laser beam LB from the surface of the workpiece W in the negative z-axis direction of the coordinate system C.

Since the parameter setting method in the parameter setting image 130′ for “Frequency”, “Duty” and “Defocus” is the same as in the parameter setting image 130 for “Power”, detailed description thereof is omitted. For example, in the parameter setting image 130′ for “Defocus”, the operator sets the shift distance LP4 so as to shift the focus of the laser beam LB at positions corresponding to the four vertices of the movement path MP having the above-described square shape.

Alternatively, the operator sets the duty ratio LP3 to decrease at the positions corresponding to the four vertices of the square movement path MP in the parameter setting image 130′ for “Duty”. This can suppress overheating in the workpiece W at the four vertex positions on the movement path MP.

The operator sets to adjust the pulse frequency at the desired position on the movement path MP in the parameter setting image 130′ for “Frequency”. Here, when the laser process is laser cutting, cutting quality can be improved by adjusting the pulse frequency in an acceleration/deceleration portion of the laser beam LB. Thus, it is possible to control the finish quality of the laser process at a desired position by adjusting the pulse frequency appropriately at the desired position on the movement path MP.

In the parameter setting image 106 illustrated in FIG. 4, when the operator inputs the “Time length” in the numerical value input image 114, the processor 52 may automatically determine whether the input time length t_{S} is within a permissible range. As an example, the processor 52 determines, from the input time length t_{S}, a time length τ required to scan a predetermined section of the movement path MP (e.g., for the square movement path MP, the section from start point P1 to the position of the first vertex) with the laser beam LB. The processor 52 then determines that the time length t_{S} is outside of the permissible range when the time length τ is shorter than or equal to a predetermined threshold value τₜₕ (e.g., τₜₕ=500 μsec) (τ≤τₜₕ).

Alternatively, the processor 52 may determine a maximum scan speed V_{S} from the input time length t_{S} and determine that the time length t_{S} is outside of the permissible range when the maximum scan speed V_{S} is greater than or equal to a predetermined threshold value Vₜₕ (e.g., Vₜₕ=3000 mm/sec) (V_{S}≥Vₜₕ). When determining that the time length t_{S} is outside of the permissible range, the processor 52 may output an alarm in the form of audio or an image to inform the operator as such. With this configuration, the operator can quickly and intuitively recognize whether the input time length t_{S} is correct.

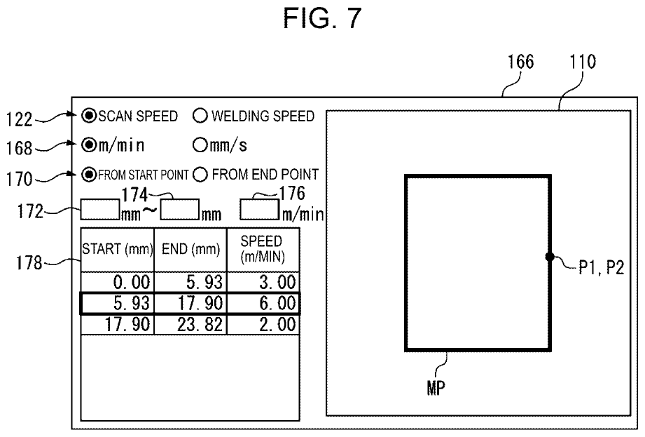

Through the speed setting image 124 illustrated in FIG. 4, the scan speed V_{S} or the welding speed V_{W} may be configured so as to be able to be set precisely for each predetermined section of the movement path MP. This function will be described with reference to FIG. 4 and FIG. 7. When the operator operates the input device 60 and clicks on the speed setting image 124 displayed in the parameter setting image 106, the processor 52 generates a parameter setting image 166 illustrated in FIG. 7, and superimposes and displays the generated image onto the speed setting image 124 in the parameter setting image 106.

The parameter setting image 166 displays the path image 110, the speed selection image 122, a unit selection image 168, a start point/end point assign image 170, numerical value input images 172, 174 and 176, and a speed display image 178. The operator can operate the input device 60 to select one of “Scan speed” and “Welding speed” in the speed selection image 122. The following describes a case in which “Scan speed” is selected in the speed selection image 122 as illustrated in FIG. 7.

The unit selection image 168 displays options “m/min” and “mm/sec” as units of speed, allowing the operator to operate the input device 60 to select one of these two options in the image. In the example illustrated in FIG. 7, the unit “m/min” is selected.

The start point/end point assign image 170 illustrates options “From start point” and “From end point”, allowing the operator to select one of these two options in the image. For example, when the option “From start point” is selected, the processor 52 designates, as the start point P1 of the movement path MP, a reference point of a section S for setting the scan speed V_{S} of the laser beam LB that moves along the movement path MP. On the other hand, when the option “From end point” is selected, the processor 52 designates as the end point P2 of the movement path MP, the reference point of the section S for setting the scan speed V_{S}.

The numerical value input images 172 and 174 are for inputting the section S of the movement path MP for setting the scan speed V_{S}. Specifically, in the numerical value input image 172, a distance d₁ from the reference point to a start point of the section S can be input, while in the numerical value input image 174, a distance d₂ from the reference point to an end point of the section S can be input. The start point/end point assign image 170, and the numerical value input images 172 and 174 allow the section S in the movement path MP to be set. A specific example of setting the section S is described below.

The numerical value input image 176 is for inputting the scan speed V_{S} in the set section S. For example, it is assumed that the operator selects the option “From start point” in the start point/end point assign image 170, inputs d₁=0.00 mm in the numerical value input image 172, d₂=5.93 mm in the numerical value input image 174, and V_{S}=3.00 m/min in the numerical value input image 176.

In this case, the processor 52 sets the start point of the section S to a position advanced by a distance d₁=0.00 mm from the start point P1 of the movement path MP (i.e., the start point P1), while setting the end point of the section S to a position advanced by a distance d₂=5.93 mm from the start point P1. That is, in this case, the section S is set as a section from the distance d₁ to distance d₂ as viewed from the start point P1 (in the present example, a section from the start point P1 to the distance d₂). The processor 52 then registers the scan speed V_{S} of the set section S as V_{S}=3.00 m/min.

On the other hand, it is assumed that the operator selects the option “From end point” in the start point/end point assign image 170, inputs d₁=0.00 mm in the numerical value input image 172, d₂=5.93 mm in the numerical value input image 174, and V_{S}=3.00 m/min in the numerical value input image 176. In this case, the processor 52 sets the start point of the section S to a position receded by a distance d₁=0.00 mm from the end point P2 of the movement path MP (i.e., the end point P2), while setting the end point of the section S to a position receded by a distance d₂=5.93 mm from the end point P2.

That is, in this case, the section S is set as a section from the distance d₁ to the distance d₂ as viewed from the end point P2 (in this example, a section from the end point P2 to the distance d₂). The processor 52 then registers the scan speed V_{S} of the set section S as V_{S}=3.00 m/min. Thus, the operator can precisely set the scan speed V_{S} for each section S freely set in the movement path MP.

The speed display image 178 displays the set section S and the scan speed V_{S} in the section S in a list format. In the example illustrated in FIG. 7, “Start (mm)” in the speed display image 178 indicates the distance d₁ that defines the start point of the section S, and “End (mm)” indicates the distance d₂ that defines the end point of the section S.

In the example illustrated in FIG. 7, a section S1 (the section at a distance 0 mm to 5.93 mm from the start point P1) is set in the first row of the speed display image 178, and “Speed (m/min)” of the section S1 is registered as V_{S}=3 m/min. In the second row of the speed display image 178, a section S2 (the section at a distance 5.93 mm to 17.9 mm from the start point P1) is set, and “Speed (m/min)” of the section S2 is registered as V_{S}=6 m/min.

In the third row of the speed display image 178, a section S3 (the section at a distance 17.9 mm to 23.82 mm from the start point P1) is set, and “Speed (m/min)” of the section S3 is registered as V_{S}=2 m/min. In this example, the scan speed V_{S} has a maximum speed V_{S_MAX} of 6 m/min, while a minimum speed V_{S_MIN} is 2 m/min. The processor 52 obtains, in accordance with the scan speed V_{S} input to the parameter setting image 166, the maximum speed V_{S_MAX} and the minimum speed V_{S_MIN} and displays these in the speed setting image 124 in FIG. 4.

When the section S (the sections S1, S2, S3) is set through the start point/end point assign image 170 and the numerical value input images 172 and 174, the processor 52 may display the section S in the path image 110 in the parameter setting image 166 so as to be visually recognizable. For example, it is assumed that the operator operates the input device 60 to select the section S2 of the second row from among the plurality of sections S1 to S3 illustrated in the speed display image 178 (see the speed display image 178 in FIG. 7). In this case, the processor 52 may display the selected section S2 in the path image 110 so as to be visually recognized.

Together with this, the processor 52 automatically calculates the above-described time length is from the scan speed V_{S} input in the parameter setting image 166, the welding line length 1 input in the welding line length image 126 (FIG. 4), and the number of times N input in the numerical value input image 120, and displays the calculated value in the numerical value input image 114. Note that since the method of setting the speed when “Welding speed” is selected in the speed selection image 122 is also the same as for “Scan speed”, detailed description thereof is omitted. According to the present embodiment, the operator can precisely set the speed V (in the present example, the scan speed V_{S}) of the laser beam LB, thus making it possible to teach more various operations of the laser process.

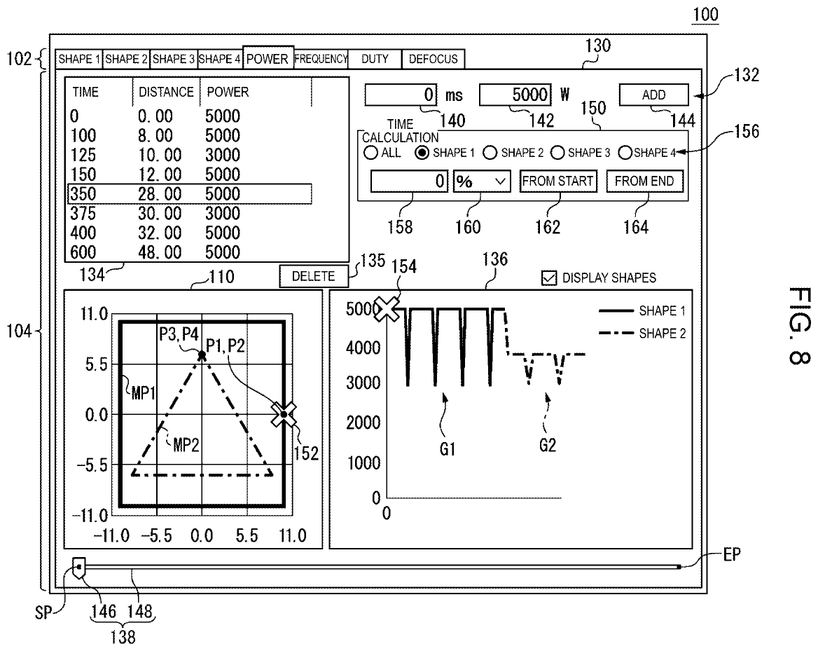

In the above embodiment, the case is described in which only the movement path MP having “Shape 1” is set. However, in addition to “Shape 1”, “Shape 2”, “Shape 3”, and “Shape 4” can be additionally set. A case of setting the movement path MP having a plurality of shapes will be described below with reference to FIG. 8.

In the present embodiment, a movement path MP1 with the above square shape is set as “Shape 1” and a movement path MP2 with a triangular shape is set as “Shape 2”. The operator can display the parameter setting image 106 corresponding to “Shape 2” by clicking on the “Shape 2” tab displayed in the tab image area 102, and can set various parameters of “Shape 2” through the parameter setting image 106.

FIG. 8 illustrates the parameter setting image 130 corresponding to the “Power” tab when “Shape 1” and “Shape 2” are set. In the example illustrated in FIG. 8, the movement path MP1 having “Shape 1” and the movement path MP2 having “Shape 2” are displayed in the path image 110. The movement path MP2 has a start point P3 and an end point P4.

In the laser process according to the present embodiment, the laser processing device 12 first causes the laser beam LB to scan along the movement path MP1 a number of times N1 set in the parameter setting image 130 of “Shape 1”, and then causes the laser beam LB to scan along the movement path MP2 by a number of times N2 set in the parameter setting image 130 of “Shape 2”.

In other words, the movement path MP in the laser process according to the present embodiment can be expressed as a path of MP=MP1×N1+MP2×N2. For example, when the laser process is laser welding, this movement path MP (=MP1×N1+MP2×N2) is set for one work target position TP (i.e., welding point), and the laser processing device 12 welds the one work target position TP by causing the laser beam LB to scan along the movement path MP for the one work target position TP.

In the graph image 136, a graph G1 corresponding to “Shape 1” and a graph G2 corresponding to “Shape 2” are displayed side by side. The graph G2 is displayed on the right side of the graph G1 so as to follow the graph G1 in the order of the progress parameter PP (elapsed time length tₑ). In the example illustrated in FIG. 8, the end point EP of the section 148 illustrated in the slider image 138 is a time length t_{SUM} (=t_{S_1}+t_{S_2}), which is the sum of a time length t_{S_1} set through the “Time length” in the parameter setting image 130 of “Shape 1” and a time length is t_{S_2} set through the “Time length” in the parameter setting image 130 of “Shape 2”.

The marks 152 and 154 are displayed in the path image 110 and the graph image 136, respectively. As the operator moves the slider 146 along the section 148, the elapsed time length tₑ designated by the slider 146 changes, and in response to this, the processor 52 updates the path image 110 and the graph image 136 so as to displace the mark 152 in the path image 110 and the mark 154 in the graph image 136.

Specifically, as the slider 146 moves from the start point SP to the end point EP, the mark 152 is displayed in the path image 110 so as to repeatedly circle along the movement path MP1 the number of times N1 and then along the movement path MP2 the number of times N2. Additionally, as the slider 146 moves from the start point SP to the end point EP, the mark 154 is displayed in the graph image 136 so as to pass through the graph G1 in the graph image 136 and then through the graph G2.

The operator can freely designate the progress parameter PP (the elapsed time length tₑ) by moving the slider 146 in the image, and can freely input the laser parameter LP (the laser power LP1) corresponding to the designated progress parameter PP (the elapsed time length tₑ) into the laser parameter input image 142 in the data set input image 132. The data-set image 134 then displays the registered data sets DS in list form in the order of the magnitude of the progress parameter PP (e.g., “Time”).

In the example illustrated in FIG. 8, “All”, “Shape 1”, or “Shape 2” can be selected in the shape selection image 156. When the operator selects “All”, the elapsed time length tₑ can be obtained from the distance d or the progress rate R, when performing the laser process along the movement path MP (=MP1×N1+MP2×N2).

As an example, it is assumed that the operator selects “All” in the shape selection image 156, selects the distance d in the parameter selection image 160, selects “From end” in the end point assign image 164, and inputs d=30 mm in the numerical value input image 158. In this case, the processor 52 obtains “Time” (the elapsed time length tₑ) corresponding to a position on the movement path MP receded from the end point EP (in the present example, the end point P4 of the movement path MP2 that is reached when the laser beam LB scans the movement path MP1 the number of times N1 and then the movement path MP2 the number of times N2) of the laser process by a distance d=30 mm.

As another example, it is assumed that the operator selects “All” in the shape selection image 156, selects the progress rate R1 in the parameter selection image 160, selects “From start” in the start point assign image 162, and inputs R1=10% in the numerical value input image 158. In this case, the processor 52 obtains, from the equation R1=tₑ/tₜ=0.1, the “Time” (the elapsed time length tₑ) from the start point SP (the start point P1) of the laser process. In the present embodiment, the total required time length tₜ is the sum t_{SUM} as described above (tₜ=t_{SUM}).

As still another example, it is assumed that the operator selects “All” in the shape selection image 156, selects the progress rate R2 in the parameter selection image 160, selects “From start” in the start point assign image 162, and inputs R2=10% in the numerical value input image 158. In this case, the processor 52 obtains the “Time” (the elapsed time length tₑ) corresponding to the position on the movement path MP advanced by a distance d=dₜ×0.1 from the start point SP of the laser process. In the present embodiment, the total distance dₜ is the distance of the movement path MP (=MP1×N1+MP2×N2).

The processor 52 then displays, in the laser parameter input image 142, the obtained “Time” (the elapsed time length tₑ) in the progress parameter input image 140 and the laser parameter LP (the laser power LP1) corresponding to the elapsed time length tₑ, which is now stored as a data set DS. Thus, the operator can optionally add a movement path MP having a plurality of “Shapes”.

In the above embodiment, the case is described in which the elapsed time length tₑ is selected as the progress parameter PP. However, the distance d, the progress rate R1 or R2 may be selected as the progress parameter PP. In this case, in the parameter setting image 130 or 130′, the “Time” displayed in the data-set image 134, the value input in the progress parameter input image 140, the horizontal axis of the graph image 136, and the section 148 of the slider image 138 indicate the selected distance d, the progress rate R1 or R2. The time calculation image 150 is configured to obtain the selected distance d, the progress rate R1 or R2 from the other progress parameters PP.

The data set input image 132 is not limited to the example illustrated in the drawing and may be generated as any image as long as the data set DS can be input. The data set input image 132 can be omitted from the parameter setting image 130 or 130′. In this case, for example, the teaching device 50 may be configured so that the operator can operate the input device 60 to input a data set DS into the data-set image 134.

The teaching device 50 may be configured so that the operator can operate the input device 60 to select a registered data set DS in the data-set image 134 and change the laser parameter LP (the laser power LP1) of the selected data set DS. In this case, the data-set image 134 acts as the input image for inputting the data set DS.

The image of the section 148 may be omitted from the slider image 138. In this case, only the slider 146 is displayed in the slider image 138, and the processor 52 displays the slider 146 in response to an input signal from the operator so as to move within the section 148 that is not visually illustrated in the slider image 138.

The slider image 138 can be omitted from the parameter setting image 130 or 130′. In this case, the operator can designate/input the progress parameter PP by, for example, manually inputting the progress parameter PP in the progress parameter input image 140 of the input image 132.

Alternatively, the operator may operate the input device 60 to designate location of choice on the movement path MP (MP1, MP2) in the path image 110 displayed in the parameter setting image 130 or 130′ by clicking on the image. In this case, the processor 52 may specify the position on the movement path MP designated by the operator and highlight the specified position on the movement path MP with the mark 152.

The processor 52 may then display, in the progress parameter input image 140, the progress parameter PP (e.g., the elapsed time length tₑ) corresponding to the position on the specified movement path MP, and display, in the laser parameter input image 142, the laser parameter LP (e.g., the laser power LP1) corresponding to the progress parameter PP.

Alternatively, the operator may operate the input device 60 to designate a position of choice in the graph G (G1, G2) in the graph image 136 displayed in the parameter setting image 130 or 130′ by clicking on the image. In this case, the processor 52 may specify the position in the graph G designated by the operator and highlight the specified position in the graph G with the mark 154.

The processor 52 may then display, in the progress parameter input image 140, the progress parameter PP (the elapsed time length tₑ) corresponding to the specified position in the graph G, and display, in the laser parameter input image 142, the laser parameter LP (the laser power LP1) corresponding to the progress parameter PP.

At this time, the processor 52 may specify the position on the movement path MP corresponding to the specified position in the graph G via the progress parameter PP, and highlight the specified position on the movement path MP with the mark 152. Thus, even when the slider image 138 is omitted, the operator can freely adjust the laser parameter LP to a desired position on the movement path MP while visually recognizing the path image 110.

The GUI of the teaching image 100 illustrated in FIG. 4 to FIG. 8 is an example, and any other GUI configuration may be adopted. In the above embodiment, the case is described in which the teaching device 50 is provided separately from the control device 14. However, the functions of the teaching device 50 can also be incorporated into the control device 14. In this case, the processor and memory of the control device 14 are included in the teaching device 50, and the processor of the control device 14 executes the various functions of the teaching device 50 described above.

FIG. 3 illustrates an example of the laser irradiation device 18 as a laser scanner, but the laser irradiation device 18 is not limited to a laser scanner and may also be a laser processing head including only the housing 24, the light receiver 26, the optical lens 36, the lens drive device 38, and the emitter 40. Additionally, the moving mechanism 20 may be configured to move the workpiece W relative to the laser irradiation device 18. As described above, the present disclosure has been described through the use of the embodiments, but the above embodiments do not limit the invention as set forth in the claims.

### REFERENCE SIGNS LIST

10 LASER PROCESSING SYSTEM
12 LASER PROCESSING DEVICE
14 CONTROL DEVICE
16 LASER OSCILLATOR
18 LASER IRRADIATION DEVICE
20 MOVING MECHANISM
50 TEACHING DEVICE
52 PROCESSOR
100 TEACHING IMAGE
110 PATH IMAGE
132 DATA SET INPUT IMAGE
134 DATA-SET IMAGE
136 GRAPH IMAGE
138 SLIDER IMAGE

1. A teaching device for teaching an operation of a laser processing device configured to perform a laser process on a workpiece by moving a laser beam irradiated on the workpiece relative to the workpiece,
the teaching device comprising a processor configured to:
generate a path image that displays a movement path along which the laser processing device moves the laser beam relative to the workpiece in the laser process;
generate an input image for inputting a data set of a progress parameter indicating a progress of the laser process and a laser parameter of the laser beam; and
display, in the path image, a position on the movement path corresponding to the progress parameter.

2. The teaching device of claim 1, wherein the processor is configured to:
further generate a graph image that displays a graph representing a relationship between the progress parameter and the laser parameter; and
display, in the graph image, a position in the graph corresponding to the progress parameter.

3. The teaching device of claim 1, wherein the processor is configured to further generate a data-set image that displays a plurality of the data sets side by side in an order of a magnitude of the progress parameter.

4. The teaching device of claim 1, wherein the processor is configured to:
further generate a slider image that displays a slider for designating the progress parameter, the slider being displayed so as to move in a section from a start point to an end point of the progress parameter in response to an input signal; and
display, in the path image, the position on the movement path corresponding to the progress parameter designated by the slider.

5. The teaching device of claim 1, wherein the progress parameter includes:
an elapsed time from a start of the laser process;
a distance by which the laser processing device moves the laser beam along the movement path from the start of the laser process; or
a progress rate of the laser process.

6. The teaching device of claim 1, wherein the laser parameter includes:
a laser power of the laser beam;
a frequency of the laser beam;
a duty ratio of the laser beam; or
a shift distance by which a focus of the laser beam is shifted from a surface of the workpiece.

7. A teaching method of teaching an operation of a laser processing device configured to perform a laser process on a workpiece by moving a laser beam irradiated on the workpiece relative to the workpiece, the teaching method comprising:
generating, by a processor, a path image that displays a movement path along which the laser processing device moves the laser beam relative to the workpiece in the laser process;
generating, by a processor, an input image for inputting a data set of a progress parameter indicating a progress of the laser process and a laser parameter of the laser beam; and
displaying, by a processor, in the path image, a position on the movement path corresponding to the progress parameter.
